(19) United States
(12) Patent Application Publication
(10) Pub. No.: US 2025/0150745 A1
(43) Pub. Date: May 8, 2025

(54) ROTATABLE HEADPHONE FOR RESTING ON USER’S NECK

(71) Applicant: Dongguan Pure Audio Technology Co., Ltd., Dongguan (CN)

(72) Inventor: CHUN-CHUN HO, New Taipei (TW)

(21) Appl. No.: 18/532,881

(22) Filed: Dec. 7, 2023

(30) Foreign Application Priority Data
Nov. 8, 2023 (CN) 202311488331.X

(51) Int. Cl. H04R 1/10

(52) U.S. Cl. CPC H04R 1/1066; H04R 1/1008; H04R 1/1025; H04R 1/1041; H04R 1/105; H04R 2460/13

(57) ABSTRACT

A rotatable headphone includes a headphone core, an ear-hanging component, and a neck-hanging component. The headphone core configured to generate sound. The ear-hanging component configured to be worn around a user's ear, wherein the headphone core is connected to one end portion of the ear-hanging component. Another end portion of the ear-hanging component is connected to the neck-hanging component, the neck-hanging component includes a movable portion and a fixing portion, the movable portion is rotatably connected to the fixing portion, the ear-hanging component is connected to one end portion of the fixing portion away from the movable portion, the movable portion is configured to be worn around a back side of the user's neck, and the fixing portion is configured to be worn around a front side of the user's neck.

### FIELD

The subject matter herein generally relates to audio devices, and more particularly to a rotatable headphone capable for resting on user's neck for enhancing the user's experience.

### BACKGROUND

Headphones are widely used in daily life. The headphone may include a neck-hanging component and two ear-hanging components connected to the neck-hanging component. The neck-hanging component may be rested around the user's neck, and the ear-hanging components are used to be rested around the user's ears.

However, a rigid connection between the neck-hanging component and the ear-hanging components prevents the neck-hanging component from be movably adjusted relative to the ear-hanging components. Thus, when the user lies down, the neck-hanging component may not adapt well to the user's neck, causing discomfort to the user.

### BRIEF DESCRIPTION OF THE DRAWINGS

Implementations of the present disclosure will now be described, by way of embodiments, with reference to the attached figures.

FIG. 1 is a diagrammatic view of a rotatable headphone according to an embodiment of this application.

FIG. 2 is an exploded view of a fixing portion of the rotatable headphone in FIG. 1.

FIG. 3 is a partial cross-sectional view of the fixing portion along line III-III in FIG. 1.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein can be practiced without these specific details. In other instances, methods, procedures, and components have not been described in detail so as not to obscure the related relevant feature being described. Also, the description is not to be considered as limiting the scope of the embodiments described herein. The drawings are not necessarily to scale, and the proportions of certain parts may be exaggerated to better illustrate details and features of the present disclosure.

The disclosure is illustrated by way of example and not by way of limitation in the figures of the accompanying drawings, in which like references indicate similar elements. It should be noted that references to “an” or “one” embodiment in this disclosure are not necessarily to the same embodiment, and such references mean “at least one.”

The term “comprising,” when utilized, means “including, but not necessarily limited to”; it specifically indicates open-ended inclusion or membership in the so-described combination, group, series, and the like.

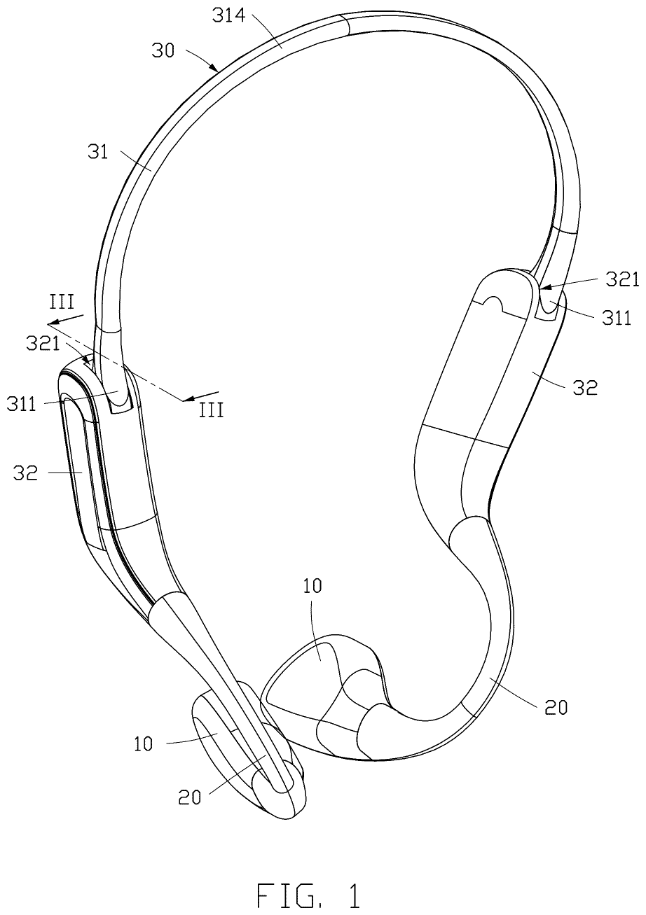

Referring to FIG. 1, an embodiment of the present application provides a rotatable headphone for resting on user's neck (hereinafter, “headphone 100”). The headphone 100 includes two headphone cores 10, two ear-hanging components 20, and a neck-hanging component 30. The neck-hanging component 30 includes two end portions. Each end portion of the neck-hanging component 30 connects to an end of a respective one of the ear-hanging components 20. Another end of each ear-hanging component 20 connects to a respective one of the headphone cores 10.

The neck-hanging component 30 is generally U-shaped. The neck-hanging component 30 matches a user's neck in shape. Each of the ear-hanging components 20 is generally n-shaped. The ear-hanging components 20 are designed to hang around the user's ears. The headphone cores 10 are generally spindle-shaped. The headphone cores 10 are positioned near the temples of the user, and can convert electrical signals into mechanical vibrations, thereby generating sound.

In some embodiments, the neck-hanging component 30 includes a movable portion 31 and two fixing portions 32. The movable portion 31 includes two ends. Each end of the movable portion 31 is rotatably connected to an end of a respective one of the fixing portions 32. Each ear-hanging component 20 is connected to another end of a respective one of the fixing portions 32 away from the movable portion 31. The movable portion 31 is used to be worn around the back side of the user's neck or other areas, while the fixing portions 32 are used to be worn the front side of the neck. Thus, when the user stands upright, the movable portion 31 can be worn around the back side of the user's neck. When the user lies down, the movable portion 31 can be rotated relative to the fixing portions 32 and then be worn around other parts of the human body (for example, the head), thereby reducing the pressure of the movable portion 31 applied on the back side of the user's neck and enhancing the comfort.

In some embodiments, each of the fixing portions 32 is generally a hollow box. The end of the fixing portion 32 connected to the movable portion 31 defines a slot 321. The movable portion 31 is generally U-shaped, and includes a rotatable body 311 at each of the ends connected to the fixing portion 32. The rotatable body 311 is inserted into the slot 321 and can rotate within the slot 321 by 0 degree to 90 degrees. In other embodiments, the slot 321 may be defined on the movable portion 31, and the rotatable body 311 is arranged on the fixing portion 32.

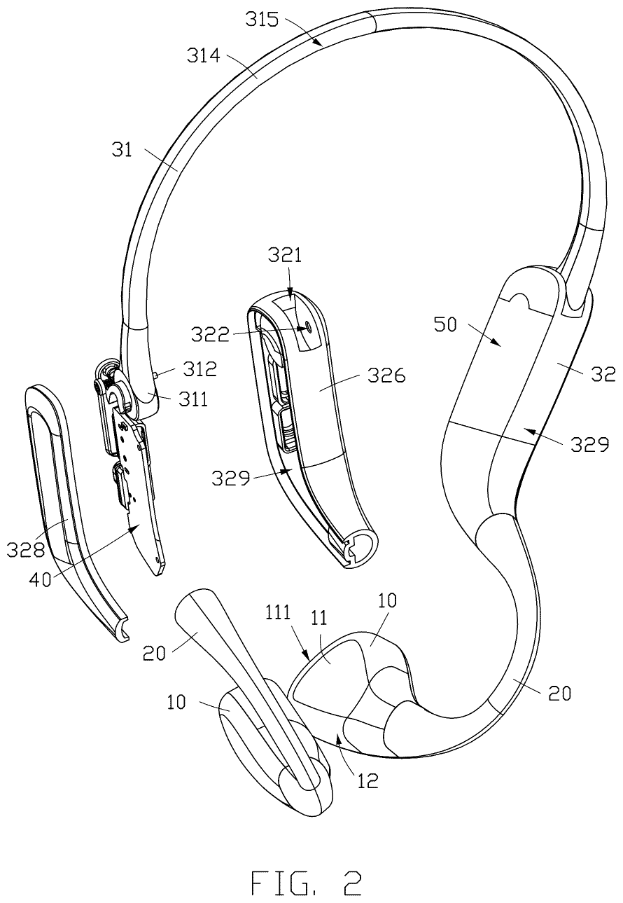

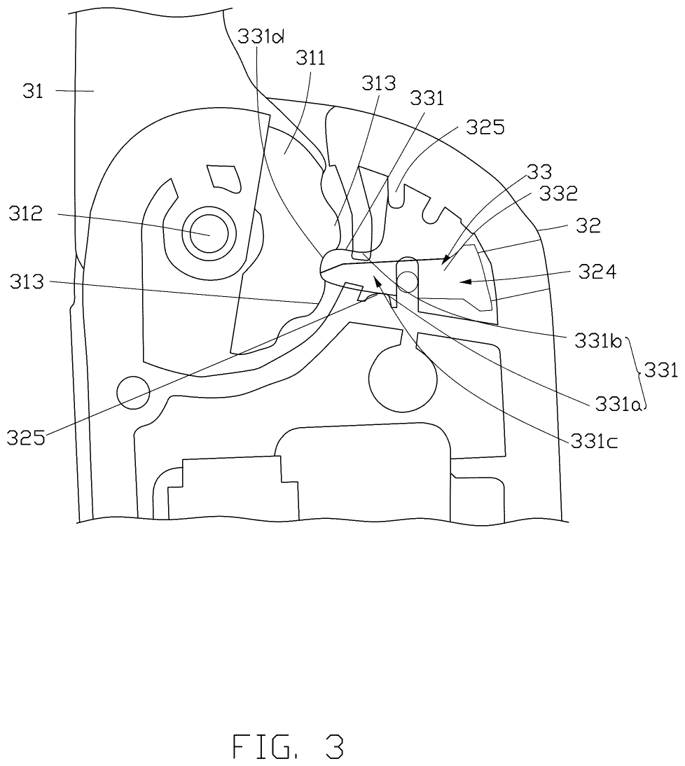

Referring to FIGS. 2 and 3, in some embodiments, a central portion of the rotatable body 311 protrudes outward to form a shaft 312, and a sidewall of the slot 321 defines a hole 322. The shaft 312 is inserted into the hole 322 and can rotate relative to the hole 322. This design allows the rotatable body 311 to rotate within the slot 321 while preventing the rotatable body 311 from separating from the slot 321. In other embodiments, the engagement manner between the slot 321 and rotatable body 311 can also be changed.

In some embodiments, an edge of the rotatable body 311 is provided with a plurality of protrusions 313, which are spaced from each other and smoothly connected to the edge of the rotatable body 311. Each fixing portion 32 also include a blocking piece 33, which partially extends into the slot 321 and abuts against two of the plurality of protrusions 313, preventing the movable portion 31 from rotating due to its own weight.

In some embodiments, the blocking piece 33 includes an elastic member 331 and a fixing column 332. The elastic member 331 is generally n-shaped. The elastic member 331 includes a first portion 331a and a second portion 331b connected to the first portion 331a at an intersection point 331d. The first and second portions 331a, 331b are arranged at an acute angle, forming an accommodating space 331c therebetween. One end of the fixing column 332 is fixed to the fixing portion 32, and the other end of the fixing column 332 inserts into the accommodating space 331c and pushes the intersection point of first and second portions 331a, 331b to abut against the two protrusions 313, thereby limiting the position of the elastic member 331. The material of the elastic member 331 can be stainless steel or Teflon.

In some embodiments, the fixing portion 32 includes a receiving slot 324, and multiple stopper 325 protrude from an inner surface of the receiving slot 324. The first portion 331a and the second portion 331b is clipped into the receiving slot 324. The stopper 325 limit the movement of the first portion 311a and the second portion 331b, thereby securing the elastic member 331 within the receiving slot 324.

Referring FIG. 2, in some embodiments, the headphone 100 further includes an electronic control component 40 and a battery component 50. The electronic control component 40 is housed in one of the fixing portions 32, and the battery component 50 is housed in the other fixing portion 32. A wire tube 314 is provided within the movable portion 31 and connects the electronic control component 40 and the battery component 50 through wires 315. Each fixing portion 32 includes a box body 326 and a cover 328. The cover 328 covers the box body 326 to form a receiving space 329, within which the battery component 50 or the electronic control component 40 is housed. The electronic control component 40 includes components such as an audio amplifier chip, a digital-to-analog conversion chip, a Bluetooth module, a microphone, and a touch chip. The battery component 50 includes components such as a lithium-ion battery, a battery management chip, a charging interface, and a power switch. The battery component 50 is used to energize relative components of the headphone 100 and facilitating quick charging.

In some embodiments, the headphone core 10 includes a core casing 11 and a transducer 12. The core casing 11 connects to one end of the ear-hanging component 20 and is used to be in contact with the user's skin. The core casing 11 forms a housing cavity 111, and the transducer 12 is placed in the housing cavity 111 and connected to the core casing 11. When the user wears the headphone 100, the transducer 12 converts electrical signals into mechanical vibrations, which drives the core casing 11 that is in contact with the skin to produce mechanical vibrations. These vibrations are transmitted through the user's bones and nerves, allowing the user to hear the bone-conducted sound from headphone core 10. In this embodiment, the transducer 12 is a vibration motor.

It is to be understood, even though information and advantages of the present embodiments have been set forth in the foregoing description, together with details of the structures and functions of the present embodiments, the disclosure is illustrative only; changes may be made in detail, especially in matters of shape, size, and arrangement of parts within the principles of the present embodiments to the full extent indicated by the plain meaning of the terms in which the appended claims are expressed.

What is claimed is:

1. A rotatable headphone comprising:
a headphone core configured to generate sound;
an ear-hanging component configured to be worn around an ear of a user, wherein the headphone core is connected to one end portion of the ear-hanging component; and
a neck-hanging component, wherein another end portion of the ear-hanging component is connected to the neck-hanging component, the neck-hanging component comprises a movable portion and a fixing portion, the movable portion is rotatably connected to the fixing portion, the ear-hanging component is connected to an end portion of the fixing portion away from the movable portion, the movable portion is configured to be worn around a back side of a neck of the user, and the fixing portion is configured to be worn around a front side of the neck.

2. The rotatable headphone of claim 1, wherein the fixing portion defines a slot, the movable portion comprises a rotatable body, the rotatable body is insertable into the slot, and the rotatable body is rotatable in the slot.

3. The rotatable headphone of claim 2, wherein the rotatable body is rotatable in the slot in a range between 0 degree to 90 degrees.

4. The rotatable headphone of claim 2, wherein a central portion of the rotatable body protrudes outward to form a shaft, a sidewall of the slot defines a hole, the shaft is insertable into the hole, and the shaft is configured to rotate in the hole.

5. The rotatable headphone of claim 2, wherein an edge of the rotatable body is provided with a plurality of protrusions, the fixing portion further comprises a blocking piece, the blocking piece partially extends into the slot, and is configured to abut against two of the plurality of protrusions.

6. The rotatable headphone of claim 5, wherein the blocking piece comprises an elastic member and a fixing column, the elastic member comprises a first portion and a second portion connected to the first portion at an intersection point, the first and the second portions cooperatively form an accommodating space, one end of the fixing column is fixed to the fixing portion, another end of the fixing column is insertable into the accommodating space and configured to push the intersection point to abut against the two protrusions which the blocking piece is abutting.

7. The rotatable headphone of claim 6, wherein the elastic member is made of stainless steel or Teflon.

8. The rotatable headphone of claim 6, wherein the fixing portion comprises a receiving slot and a plurality of stoppers protruding from an inner surface of the receiving slot, the first and the second portions of the elastic member are in the receiving slot, and the plurality of stoppers is configured to limit a movement of the first and the second portions.

9. The rotatable headphone of claim 2, the rotatable headphone further comprising two fixing portions and two movable portions, wherein the two fixing portions are respectively positioned at either end portions of the movable portion.

10. The rotatable headphone of claim 9, further comprising an electronic control component and a battery component, wherein the electronic control component is housed in one of the two fixing portions, and the battery component is housed in another one of the two fixing portions.

11. The rotatable headphone of claim 9, further comprising wires, wherein the movable portion further comprises a wire tube configured for receiving the wires, and the electronic control component and the battery component are electrically connected to each other through the wires.

12. The rotatable headphone of claim 9, wherein each of the two fixing portions comprises a box body and a cover, the cover covers the box body to form a receiving space, and the battery component and the electronic control component are received in the receiving space.

13. The rotatable headphone of claim 10, wherein the electronic control component comprises a Bluetooth module.

14. The rotatable headphone of claim 10, wherein the battery component comprises a lithium-ion battery.

15. The rotatable headphone of claim 1, wherein the headphone core is configured to convert electrical signals into mechanical vibrations.

16. The rotatable headphone of claim 15, wherein the headphone core comprises a core casing and a transducer, the core casing connects to one end of the ear-hanging component and is configured to be in contact with skin of the user, the core casing defines a housing cavity, the transducer is placed in the housing cavity and connected to the core casing, and the transducer is configured to convert the electrical signals into the mechanical vibrations.
